(19) United States
(12) Patent Application Publication
(10) Pub. No.: US 2025/0209844 A1
(43) Pub. Date: Jun. 26, 2025

(54) ANCIENT BOOK RECOGNITION METHOD AND APPARATUS, STORAGE MEDIUM, AND DEVICE

(71) Applicant: BEIJING YOUZHUJU NETWORK TECHNOLOGY CO., LTD., Beijing (CN)

(72) Inventors: Yuxuan ZHANG, Beijing (CN); Li LIN, Beijing (CN); Can HUANG, Beijing (CN); Changhu WANG, Beijing (CN)

(21) Appl. No.: 18/847,033

(22) PCT Filed: Feb. 2, 2023
(86) PCT No.: PCT/CN2023/074289

§ 371 Date: Sep. 13, 2024

(30) Foreign Application Priority Data
Mar. 16, 2022 (CN) 202210258636.0

(51) Int. Cl. G06V 30/19; G06V 10/44; G06V 10/764; G06V 10/77; G06V 10/82; G06V 30/146; G06V 30/148; G06V 30/18; G06V 30/28; G06V 30/413

(52) U.S. Cl. CPC G06V 30/19173; G06V 10/457; G06V 10/764; G06V 10/7715; G06V 10/82; G06V 30/147; G06V 30/15; G06V 30/18076; G06V 30/19147; G06V 30/287; G06V 30/413; G06V 2201/131

(57) ABSTRACT

Provided are a method and a device for recognizing an ancient book. The method comprises: extracting classification features of a target ancient book image based on a backbone network to obtain backbone classification features; detecting the backbone classification features and determining individual character positions and text line positions included in the target ancient book image; recognizing the individual character positions to obtain content information of individual characters, and predicting the text line positions to obtain a reading order of characters in the text line positions; and arranging, based on a ratio between the individual character positions and the text line positions, the content information of the individual characters following the reading order of the characters in the text line positions to obtain a recognition result of characters in the target ancient book image.

### CROSS-REFERENCE TO RELATED APPLICATION(S)

The present application claims the priority to Chinese Patent Application No. 202210258636.0, filed with the China National Intellectual Property Administration on Mar. 16, 2022 and entitled “Ancient Book Recognition Method and Apparatus, Storage Medium, and Device”, the disclosure of which is incorporated herein in its entirety by reference.

### FIELD

The present application relates to the technical field of image processing, and in particular to a method and apparatus for recognizing an ancient book, a storage medium and a device.

### BACKGROUND

Ancient Chinese books are often likened to vast, mist-covered oceans due to their extensive historical significance. These texts represent invaluable cultural treasures, stemming from a unique historical background. They are not only crucial for historical research but also serve as precious relics and works of art. To safeguard these treasures and facilitate their comprehensive study, the timely emergence of digitization efforts has proven essential.

Currently, during the digitization process of ancient books, the books are scanned to create electronic images. These images are then subjected to individual character detection and recognition techniques to derive a recognition result. However, ancient books often feature intricate typesetting and annotations interspersed among characters per line, deviating from the conventional left-to-right, top-to-bottom layout of modern books. As a consequence, existing image recognition methods struggle with accurately identifying ancient book images. Furthermore, the current individual character detection and recognition techniques lack consideration of the positional relationship between characters during detection, resulting in a low accuracy of the final recognition outcome. In other words, achieving a highly accurate recognition result for ancient books remains challenging.

### SUMMARY

A main objective of the examples of the present application is to provide a method and apparatus for recognizing an ancient book, a storage medium and a device, which can improve a recognition effect by aggregating individual character positions and content in an ancient book image with text line positions and a character reading direction, thereby further obtaining highly accurate recognition result of the ancient book.

A method for recognizing an ancient book is provided in some embodiments of the present application. The method includes: obtaining a target ancient book image to be recognized, and extracting classification features of the target ancient book image according to a backbone network to obtain backbone classification features; detecting the backbone classification features and determining individual character positions and text line positions included in the target ancient book image; recognizing the individual character positions to obtain content information of individual characters, and predicting the text line positions to obtain a reading order of characters in the text line positions; and arranging, according to a ratio between the individual character positions and the text line positions, the content information of the individual characters following the reading order of the characters in the text line positions to obtain a recognition result of characters in the target ancient book image.

In a possible implementation, detecting the backbone classification features and determining individual character positions included in the target ancient book image includes: inputting the backbone classification features into a convolution layer to obtain an individual character probability feature map and a background threshold feature map; determining, for each pixel in the target ancient book image, a probability that the pixel belongs to an individual character and a probability that the pixel belongs to a background according to the individual character probability feature map and the background threshold feature map; and determining, according to the probability that the pixel belongs to the individual character and the probability that the pixel belongs to the background, a minimum bounding rectangle of each individual character by obtaining a connected domain, as an individual character position corresponding to each individual character.

In a possible implementation, recognizing the individual character positions to obtain content information of individual characters includes: obtaining, by image cropping, individual character image areas corresponding to the individual character positions from the target ancient book image; and recognizing the individual characters in the individual character image areas through a neural network classifier to obtain the content information corresponding to the individual characters.

In a possible implementation, predicting the text line positions to obtain a reading order of characters in the text line positions includes: predicting the text line positions to obtain corresponding character area mask images; and predicting the reading order of the characters in text areas in the text line positions according to the character area mask images.

In a possible implementation, predicting the text line positions to obtain a reading order of characters in the text line positions includes: dividing the text line positions into squares having a preset size, and sequentially connecting midpoints of the squares to obtain the reading order of the characters in text areas in the text line positions.

In a possible implementation, arranging, according to a ratio between the individual character positions and the text line positions, the content information of the individual characters following the reading order of the characters in the text line positions to obtain a recognition result of characters in the target ancient book image includes: calculating an area of intersection of the individual character positions and the text line positions, and a ratio between the area of intersection and the individual character positions; and arranging, when the ratio satisfies a preset condition, the content information of the individual characters in the individual character positions according to the reading order of the characters in the text line positions, to obtain the recognition result of the characters in the target ancient book image.

In a possible implementation, the method further includes: receiving a correction operation for the content information of the individual characters to obtain corrected content information corresponding to the individual characters.

An apparatus for recognizing an ancient book is provided in some embodiments of the present application. The apparatus includes: an obtaining unit configured to obtain a target ancient book image to be recognized, and extract classification features of the target ancient book image according to a backbone network to obtain backbone classification features; a detecting unit configured to detect, using the backbone classification features, to determine individual character positions and text line positions included in the target ancient book image; a recognizing unit configured to recognize the individual character positions to obtain content information of individual characters, and predict the text line positions to obtain a reading order of characters in the text line positions; and an arranging unit configured to arrange, according to a ratio between the individual character positions and the text line positions, the content information of the individual characters following the reading order of the characters in the text line positions to obtain a recognition result of characters in the target ancient book image.

In a possible implementation, the detecting unit includes: an input sub-unit configured to input the backbone classification features into a convolution layer to obtain an individual character probability feature map and a background threshold feature map; a first determination sub-unit configured to determine, for each pixel in the target ancient book image, a probability that the pixel belongs to an individual character and a probability that the pixel belongs to a background according to the individual character probability feature map and the background threshold feature map; and a second determination sub-unit configured to determine, according to the probability that the pixel belongs to the individual character and the probability that the pixel belongs to the background, a minimum bounding rectangle of each individual character by obtaining a connected domain, as an individual character position corresponding to each individual character.

In a possible implementation, the recognizing unit includes: a cropping sub-unit configured to obtain, by image cropping, individual character image areas corresponding to the individual character positions from the target ancient book image; and a recognition sub-unit configured to recognize the individual characters in the individual character image areas through a neural network classifier to obtain the content information corresponding to the individual characters.

In a possible implementation, the recognizing unit includes: a first prediction sub-unit configured to predict the text line positions to obtain corresponding character area mask images; and a second prediction sub-unit configured to predict the reading order of the characters in text areas in the text line positions according to the character area mask images.

In a possible implementation, the recognizing unit is specifically configured to: divide the text line positions into squares having a preset size, and sequentially connecting midpoints of the squares to obtain the reading order of the characters in text areas in the text line positions.

In a possible implementation, the arranging unit includes: a calculation sub-unit configured to calculate an area of intersection of the individual character positions and the text line positions, and a ratio between the area of intersection and the individual character positions; and an arranging sub-unit configured to arrange, when the ratio satisfies a preset condition, the content information of the individual characters in the individual character positions according to the reading order of the characters in the text line positions, to obtain the recognition result of the characters in the target ancient book image.

In a possible implementation, the apparatus further includes: a reception unit configured to receive a correction operation for the content information of the individual characters to obtain corrected content information corresponding to the individual characters.

A device for recognizing an ancient book is further provided in some embodiments of the present application. The device includes: a processor, a memory and a system bus, where the processor is connected to the memory via the system bus; and the memory is configured to store one or more programs including instructions, which, when executed by the processor, cause the processor to execute any implementation of the method for recognizing an ancient book described above.

A computer-readable storage medium is further provided in some embodiments of the present application. The computer-readable storage medium stores instructions, which, when executed on a terminal device, causes the terminal device to execute any implementation of the method for recognizing an ancient book described above.

According to the method and apparatus for recognizing an ancient book, the storage medium and the device according to the examples of the present application, the target ancient book image to be recognized is obtained, and the classification features of the target ancient book image are extracted according to the backbone network to obtain the backbone classification features; then the backbone classification features are detected to determine the individual character positions and the text line positions included in the target ancient book image; then the individual character positions are recognized to obtain the content information of the individual characters; and the text line positions are predicted to obtain the reading order of the characters in the text line positions, and according to the ratio between the individual character positions and the text line positions, the content information of the individual characters is arranged following the reading order of the characters in the text line positions to obtain the recognition result of characters in the target ancient book image. It can be seen that the examples of the present application improve a recognition effect by aggregating the individual character positions and content in the ancient book image with the text line positions and a character reading direction; and moreover, the examples of the present application fully consider a position relation between the individual characters and the reading order of the characters in text lines when recognizing the ancient book image, thereby greatly improving recognition accuracy and recognition efficiency compared with an existing recognition method.

### BRIEF DESCRIPTION OF THE DRAWINGS

In order to more clearly illustrate the technical solutions in the examples of the present application or in the prior art, the accompanying drawings required for the description of the examples or the prior art will be briefly introduced below. Obviously, the accompanying drawings in the following description are some examples of the present application, and those of ordinary skill in the art would be further able to derive other accompanying drawings from these accompanying drawings without making creative efforts.

FIG. 1 is a schematic flow chart of a method for recognizing an ancient book according to some embodiments of the present application;

FIG. 2 is a schematic diagram of a detection process of text line positions according to some embodiments of the present application;

FIG. 3 is a second example diagram of a prediction process of a reading order of characters in text line positions according to some embodiments of the present application;

FIG. 4 is a second example diagram of a prediction process of a reading order of characters in text line positions according to some embodiments of the present application;

FIG. 5 is an example diagram of arrangement of content information of individual characters according to a reading order of characters in text line positions according to some embodiments of the present application;

FIG. 6 is an overall example diagram of ancient book recognition according to some embodiments of the present application; and

FIG. 7 is a schematic diagram of an apparatus for recognizing an ancient book according to some embodiments of the present disclosure.

### DETAILED DESCRIPTION OF EMBODIMENTS

At present, an optical character recognition (OCR) technology is usually used during image recognition. The existing OCR technology mainly uses a text line detection technology, and a text line recognition technology based on a convolutional recurrent neural network (CRNN) model and a transformer network model. Although the technology can recognize text lines more accurately, a recognition object of the technology is usually a character image of conventional typesetting. An ancient book usually has complex character typesetting and often has an annotation in a middle of characters per line different from conventional typesetting of a modern book from left to left and then from top to bottom. Consequently, the existing OCR technology has a poor effect on recognition of an ancient book image, and even fails.

Thus, in order to better digitize the ancient book, the recognition solution currently used is usually an individual character detection and recognition technology. However, the individual character detection and recognition technology does not consider a position relation between individual characters during detection of the ancient book image, resulting in an insufficiently accurate final recognition result, i.e. an incapability to obtain an ancient book recognition result having high accuracy.

In order to solve the above defect, the present disclosure provides a method for recognizing an ancient book. A target ancient book image to be recognized is obtained, and classification features of the target ancient book image are extracted according to a backbone network to obtain backbone classification features; then the backbone classification features are detected to determine individual character positions and text line positions included in the target ancient book image; then the individual character positions are recognized to obtain content information of individual characters; and the text line positions are predicted to obtain a reading order of characters in the text line positions, and according to a ratio between the individual character positions and the text line positions, the content information of the individual characters are arranged following the reading order of the characters in the text line positions to obtain a recognition result of characters in the target ancient book image. It can be seen that the examples of the present disclosure improve a recognition effect by aggregating the individual character positions and content in the ancient book image with the text line positions and a character reading direction; and moreover, the examples of the present disclosure fully consider a position relation between the individual characters and the reading order of the characters in text lines when recognizing the image, thereby greatly improving recognition accuracy and recognition efficiency compared with an existing recognition method.

In order to make the objectives, technical solutions and advantages of the examples of the present disclosure clearer, the technical solutions in the examples of the present disclosure will be clearly and completely described below in combination with the accompanying drawings in the examples of the present disclosure. Obviously, the described examples are some examples rather than all examples of the present disclosure. On the basis of the examples in the present disclosure, all other examples obtained by those of ordinary skill in the art without making creative efforts fall within the scope of protection of the present disclosure.

### Example 1

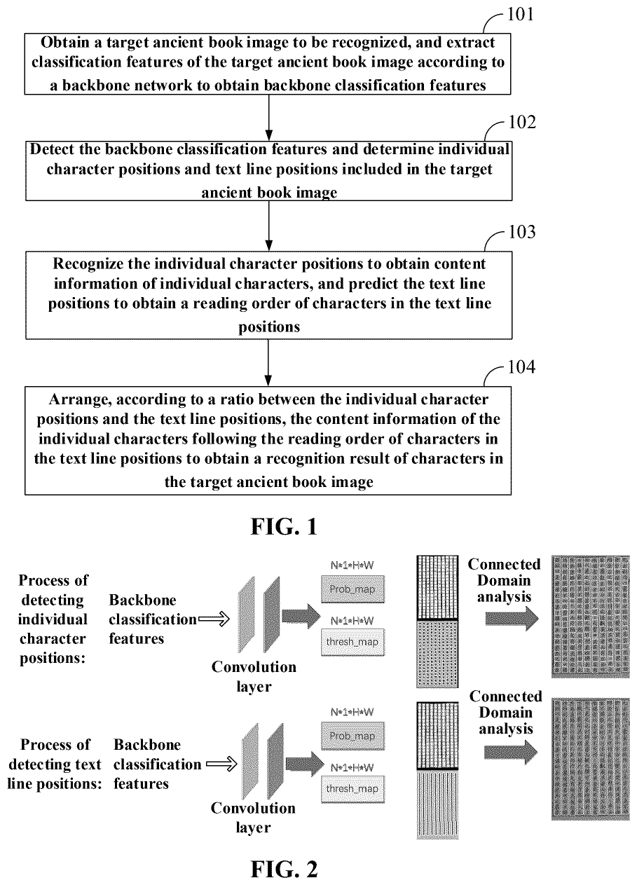

With reference to FIG. 1, a schematic flow chart of a method for recognizing an ancient book according to the example is shown. The method includes:

S101: obtain a target ancient book image to be recognized, and extract classification features of the target ancient book image according to a backbone network to obtain backbone classification features.

In the example, any ancient book image subjected to text recognition through the example is defined as a target ancient book image. Moreover, it should be noted that the type of the target ancient book image is not limited in the example. For example, the target ancient book image may be a color image consisting of three primary colors of red (R), green (G) and blue (B), or a gray image.

Moreover, a manner of obtaining the target ancient book image is also not limited in the example. The target ancient book image may be obtained by means of scanning, photographing, etc. according to actual requirements. For example, an electronic image scanned from the ancient book by a scanning device may be saved as the target ancient book image, or an ancient book image including characters photographed by a camera may be used as the target ancient book image.

Further, after the target ancient book image is obtained, individual characters and text lines of the target ancient book image are detected according to a segment-based method through an existing or future backbone network, such as a visual geometry group (VGG) network model or a deep residual network (ResNet), so as to obtain backbone classification features (i.e. features extracted through the backbone network), and then the target ancient book image is accurately recognized by executing subsequent S102-S104.

S102: detect the backbone classification features and determine individual character positions and text line positions included in the target ancient book image.

In the example, after the backbone classification features corresponding to the target ancient book image are obtained by means of S101, in order to more accurately aggregate the individual character positions and content with text line positions and a character reading direction to obtain a recognition result having high accuracy, it is further necessary to share the backbone classification features when the individual character positions and the text line positions are detected. That is, the backbone classification features are detected to determine the individual character positions and the text line positions included in the target ancient book image respectively, so as to execute subsequent S103.

Specifically, in an optional implementation, the implementation process of “detect, using the backbone classification features, to determine individual character positions included in the target ancient book image” in S102 may specifically include the following steps A1-A3:

Step A1: input the backbone classification features into a convolution layer to obtain an individual character probability feature map and a background threshold feature map.

In the implementation, in order to consider a position relation between individual characters during recognition of the target ancient book image, so as to improve accuracy of a final recognition result, after the backbone classification features of the target ancient book image are obtained, it is further necessary to input the backbone classification features into a network layer to position and classify individual characters in the target ancient book image. That is, whether each pixel in the target ancient book image belongs to an individual character or an image background is determined. Specifically, the backbone classification features may be input into the convolution layer (the specific number of layers is not limited, and may be obtained by training according to actual situations), so as to obtain the individual character probability feature map and the background threshold feature map. As shown in a “detection process of individual character positions” above FIG. 2, after the backbone classification features are input into the convolution layer, the individual character probability feature map “Prob_map” and the background threshold feature map “thresh_map” may be predicted. N above the feature map represents the number of target ancient book images processed once by means of the convolution layer; and 1 represents that the number of channels corresponding to feature vectors to be recognized in which the individual character probability feature map “Prob_map” and the background threshold feature map “thresh_map” are located is one-dimensional, H represents a height of the corresponding feature vector to be recognized, and W represents a width of the corresponding feature vector to be recognized.

Step A2: determine, for each pixel in the target ancient book image, a probability that the pixel belongs to an individual character and a probability that the pixel belongs to a background according to the individual character probability feature map and the background threshold feature map.

After the backbone classification features are input into the convolution layer in step A1 to obtain the individual character probability feature map and the background threshold feature map, each pixel on the target ancient book image can be further traversed by processing the individual character probability feature map and the background threshold feature map, and the probability that each pixel belongs to an “ancient book individual character” and the probability that each pixel belongs to the image background can be determined separately, so as to execute subsequent step A3.

Step A3: determine, according to the probability that the pixel belongs to the individual character and the probability that the pixel belongs to the background, a minimum bounding rectangle of each individual character by obtaining a connected domain, as an individual character position corresponding to each individual character.

After the probability that each pixel belongs to the “ancient book individual character” and the probability that each pixel belongs to the image background are determined in step A2, whether each pixel belongs to the “ancient book individual character” or the image background can be further determined by comparing sizes of the two probabilities. That is, when the probability that the pixel belongs to the “ancient book individual character” is greater than the probability that the pixel belongs to the image background, it is determined that the pixel belongs to the “ancient book individual character”. On the contrary, when the probability that the pixel belongs to the image background is greater than the probability that the pixel belongs to the “ancient book individual character”, it is determined that the pixel belongs to the image background.

On this basis, the minimum bounding rectangle of each “ancient book individual character” in the target ancient book image can be further determined in a manner of obtaining a connected domain. As shown in a figure above FIG. 2, each “small square” obtained after connected domain analysis is used as the individual character position corresponding to each individual character, so as to execute subsequent S103.

Similarly, in order to improve accuracy of the final recognition result, after the backbone classification features of the target ancient book image are obtained, it is further necessary to input the backbone classification features into a network layer similar to that during detection of the individual character positions, but the difference lies in more emphasis on learning of text line granularity. Therefore, it is necessary to add an output network layer of the text line granularity to position and classify each text line in the target ancient book image. That is, whether each pixel in the target ancient book image belongs to the text line position or the image background is determined. Specifically, the backbone classification features may be input into the convolution layer (the specific number of layers is not limited, and it may be obtained by training according to actual situations) for prediction, so as to obtain the text line probability feature map and the background threshold feature map. As shown in a “detection process of text line positions” below FIG. 2, after the backbone classification features are input into the convolution layer, the text line probability feature map “Prob_map” and the background threshold feature map “thresh_map” may be predicted. Similarly, N above the feature map represents the number of target ancient book images processed once by means of the convolution layer; and 1 represents that the number of channels corresponding to feature vectors to be recognized in which the individual character probability feature map “Prob_map” and the background threshold feature map “thresh_map” are located is one-dimensional, H represents a height of the corresponding feature vector to be recognized, and W represents a width of the corresponding feature vector to be recognized. For the specific implementation process, reference can also be made to steps A1-A3, which will not be repeated herein. It should be noted that compared with a traditional technology using individual character detection and recognition only, an overall recognition process of the present disclosure increases less time consumption, which is only about 20%, but provides position information of the text line granularity. Thus, the accuracy of the ancient book recognition result can be greatly improved after subsequent steps are processed.

It should be further noted that both a pre-trained individual character detection network model and a text line position detection network model can be used for the specific implementation process of determination of the individual character positions and the text line positions included in the target ancient book image in the step. The two models can be completely consistent in network structure, and the difference only lies in that network parameters learned by the two models are different. The specific model training process will not be repeated herein.

S103: recognize the individual character positions to obtain content information of individual characters, and predict the text line positions to obtain a reading order of characters in the text line positions.

In the example, after the individual character positions and the text line positions included in the target ancient book image are determined in S102, in order to more accurately aggregate the individual character positions and content with the text line positions and a character reading direction to obtain a recognition result having high accuracy, it is further necessary to recognize the individual character positions in the target ancient book image, so as to determine the content information of the individual characters, and to predict the text line positions in the target ancient book image to predict the reading order (i.e. reading direction) of the characters in the text line positions, so as to execute subsequent S104.

Specifically, in an optional implementation, the implementation process of “recognize the individual character positions to obtain content information of individual characters” in S103 may specifically include: obtain, by image cropping, individual character image areas corresponding to the individual character positions from the target ancient book image; and recognize the individual characters in the individual character image areas through a neural network classifier to obtain the content information corresponding to the individual characters.

In the implementation, in order to improve the accuracy of the recognition result, after the individual character positions are obtained, the obtained individual character positions may be further detected according to an existing or future method for detecting individual characters. Specifically, the individual character image areas corresponding to the individual character positions may be obtained by image cropping from the target ancient book image. For example, each “small square” obtained by connected domain analysis as shown in the figure above FIG. 2 may be obtained by image cropping from the target ancient book image. Then, the individual characters in each cropped image are recognized through the neural network classifier, such as a convolutional neural network (CNN), to obtain the content information corresponding to each individual character, so as to execute subsequent S104.

Furthermore, there may be some characters in an ancient book that modern people basically do not use, or other characters that do not conform to a conventional standard. Thus, in an optional implementation, after the content information corresponding to the individual characters is recognized according to the recognition model, in order to improve the accuracy of the recognition result, a correction operation for the content information of the individual characters may be further received to obtain corrected content information corresponding to individual characters, and then the recognition model is repeatedly trained through to the corrected information of the individual characters. After multiple rounds of iterative training, a recognition model having an accuracy rate satisfying a preset requirement (which can be set according to actual situations, and can set the recognition accuracy to reach 90% or above, for example) can be obtained to recognize the content information having high accuracy corresponding to the individual characters.

In another optional implementation, the implementation process of “predict the text line positions to obtain a reading order of characters in the text line positions” in S103 may specifically include: predict the text line positions to obtain corresponding character area mask images; and predict the reading order of the characters in text areas in the text line positions according to the character area mask images. The character area mask image may be considered as a foreground image of text lines separated by a smearing and restoration engine.

In the implementation, in order to improve the accuracy of the recognition result, after the text line positions are obtained, the obtained individual character positions can be further processed according to an existing or future method for obtaining character area mask images of text lines. For example, the foreground images of the text lines is separated through the smearing and restoration engine as the character area mask images of the text lines, and a character direction in the text areas in the corresponding text line positions, i.e. the reading order of characters, can be further predicted according to the recognition result of the character area mask images, so as to execute subsequent S104.

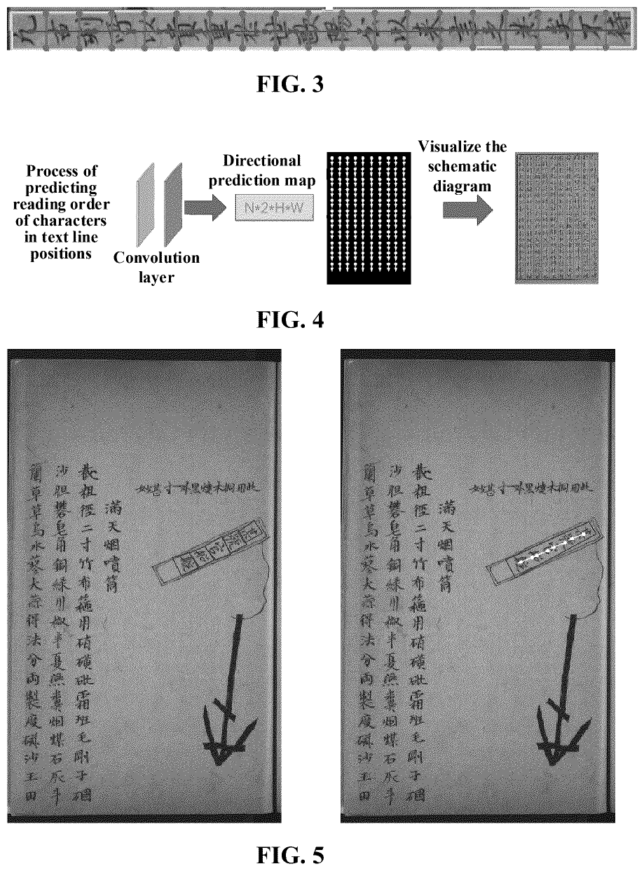

Moreover, in an optional implementation, the text line positions may be further divided into squares having a preset size, and midpoints of the squares are sequentially connected to obtain the reading order of the characters in the text areas in the text line positions. As shown in FIG. 3, an arrow indication direction in the figure represents the reading order of the characters in the text line. Moreover, in an actual prediction network, it is further necessary to predict a character direction offset in the text lines, and an annotation of the offset is generated according to an annotation of the text lines. As shown in FIG. 4, the reading order of the characters in the text lines can be predicted more accurately in combination with the text direction offset.

S104: arrange, according to a ratio between the individual character positions and the text line positions, the content information of the individual characters following the reading order of the characters in the text line positions to obtain a recognition result of characters in the target ancient book image.

It should be noted that since the characters in the ancient book are not arranged completely from top to bottom, a result that conforms to correct semantics is not necessarily obtained for detection of the individual characters by directly sorting positions on a rule. Therefore, in the example, after the content information of the individual characters and the reading order of the characters in the text line positions are determined in S103, the content information of the individual characters, the text line positions and the reading order of the characters can be further fused for recognition, so as to obtain an ancient book recognition result having high accuracy.

Specifically, in an optional implementation, the specific implementation of S104 may include the following steps B1 and B2:

Step B1: calculate an area of intersection of the individual character positions and the text line positions, and a ratio between the area of intersection and the individual character positions.

In the implementation, in order to improve the accuracy of the final recognition result, after the individual character positions and the text line positions of the target ancient book image are determined, a position relation between the individual character positions and the text line positions can be further processed to determine whether the individual character positions belong to the text line positions. That is, whether the individual characters in the individual character positions belong to the text lines is determined. Specifically, the area of intersection of the individual character positions and the text line positions can be calculated, and then, the ratio between the area of intersection and areas in which the individual character positions are located is calculated to execute subsequent B2.

Step B2: arrange, when the ratio satisfies a preset condition, the content information of the individual characters in the individual character positions according to the reading order of the characters in the text line positions, to obtain the recognition result of the characters in the target ancient book image.

After the ratio between the area of intersection of the individual character positions and the text line positions and the individual character positions is calculated in step B1, whether the ratio satisfies a preset condition can be further determined. A specific value of the preset condition can be set according to actual situations, which is not limited in the example of the present disclosure. For example, the preset condition can be set to be the ratio not less than 0.5. Thus, when it is determined that the ratio satisfies the preset condition, if the ratio is greater than 0.5, it is indicated that the individual character position belongs to the text line position, and the content information of the individual characters in the individual character positions can be further arranged according to the reading order of the characters in the text line position to obtain the character recognition result in the text line, and a recognition result in which all the characters in the target ancient book image are sorted according to the text line can be further obtained.

For example, as shown in FIG. 5, through S102 and S103 above, “small boxes” in which the individual character positions corresponding to five individual characters of “ [symbol] ”, “ [symbol] ”, “ [symbol] ”, “ [symbol] ” and “ [symbol] ” are located in a left figure may be determined, and “long boxes” in which the text line positions are located may be determined. Moreover, it may be further determined that the reading order of the characters in the text line position is in a direction shown by an arrow in a right figure. The area of intersection of a “small box” in which each of the five individual characters is located and a “long box” in which the text line position is located may be further calculated. Then, whether the individual character position belongs to the text line is determined by determining whether the ratio between the area of intersection and the individual character position satisfies the preset condition.

For example, assuming that the preset condition is that the ratio between the area of intersection of the individual character position and the text line position and the individual character position is not less than 0.5, it may be determined that the individual character position belongs to the text line position, and the content information of the individual characters in the individual character positions belonging to the text line position may be arranged according to the reading order of the characters in the text line position. In this case, if the calculated ratio between the area of intersection of the “small boxes” in which the individual character positions corresponding to the five individual characters of “ [symbol] ”, “ [symbol] ”, “ [symbol] ”, “ [symbol] ” and “ [symbol] ” are located and the “long box” in which the text line position is located and the individual character positions is greater than 0.5, that is, the ratio satisfies the preset condition, the five individual characters may be further arranged according to the reading order of the characters in the text line position (i.e. a direction indicated by an arrow in the right figure). That is, the five individual characters of “ [symbol] ”, “ [symbol] ”, “ [symbol] ”, “ [symbol] ” and “ [symbol] ” are connected to form “ [symbol] ” as the final recognition result of the characters in the target ancient book image shown in FIG. 5.

Thus, when the ancient book image is recognized through S101-S104, the position relation between the ancient book individual characters in the image and the reading order of the characters in the text line are fully considered. The individual character positions and content in the target ancient book image are aggregated with the text line positions and the character reading direction, such that the individual characters belonging to the same text line are divided into the position in which the same text line is located. Moreover, the content information of the individual characters is arranged according to the reading order of the characters in the text line position such that the recognition result having high accuracy can be obtained.

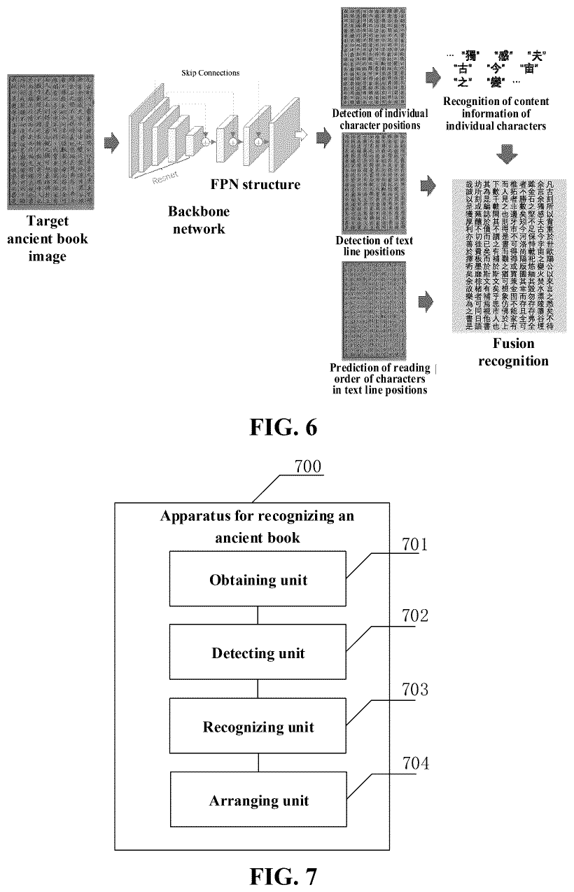

For example, as shown in FIG. 6, an overall example diagram of an ancient book recognition process according to some embodiments of the present disclosure is shown. In the specific recognition process, the target ancient book image is input into the backbone network consisting of an Resnet and a feature pyramid network (FPN) structure (used for fusion processing of different scale features) to obtain backbone classification features. Then, the backbone classification features are input into an individual character detection network and a text line position detection network models separately to detect the individual character positions and the text line positions. Then, the detected individual character positions may be recognized to obtain the content information of the individual characters, such as “ [symbol] ”, “ [symbol] ”, “ [symbol] ”, “ [symbol] ”, “ [symbol] ”, “ [symbol] ”, “ [symbol] ” and “ [symbol] ” in FIG. 6, so as to predict the detected text line positions to obtain the reading order of the characters in the text line positions, as shown by an arrow in FIG. 6. Further, the recognized content information of the individual characters such as “ [symbol] ”, “ [symbol] ”, “ [symbol] ”, “ [symbol] ”, “ [symbol] ”, “ [symbol] ”, “ [symbol] ” and “ [symbol] ” may be further arranged according to the reading order of the characters in the text lines to which the individual characters belong, so as to obtain a fusion recognition result, as shown in a figure below a rightmost side of FIG. 6. For the specific recognition and implementation process, reference can be made to the detailed introduction of S101-S104 above, which will not be repeated herein.

To sum up, according to the method for recognizing an ancient book, the target ancient book image to be recognized is obtained, and the classification features of the target ancient book image are extracted according to the backbone network to obtain the backbone classification features; then the backbone classification features are detected, the individual character positions and the text line positions included in the target ancient book image are determined; then the individual character positions are recognized to obtain the content information of the individual characters; and the text line positions are predicted to obtain the reading order of the characters in the text line positions, and according to the ratio between the individual character positions and the text line positions, the content information of the individual characters is arranged following the reading order of the characters in the text line positions to obtain the recognition result of characters in the target ancient book image. It can be seen that the examples of the present disclosure improve a recognition effect by aggregating the individual character positions and content in the ancient book image with the text line positions and a character reading direction; and moreover, the examples of the present disclosure fully consider a position relation between the individual characters and the reading order of the characters in text lines when recognizing the ancient book image, thereby greatly improving recognition accuracy and recognition efficiency compared with an existing recognition method.

### Example 2

An apparatus for recognizing an ancient book will be introduced in the example, and for the related content, reference is made to the above method example.

Refer to FIG. 7 which illustrates a schematic diagram of an apparatus for recognizing an ancient book. The apparatus 700 includes: an obtaining unit 701 configured to obtain a target ancient book image to be recognized, and extract classification features of the target ancient book image according to a backbone network to obtain backbone classification features; a detecting unit 702 configured to detect, using the backbone classification features, to determine individual character positions and text line positions included in the target ancient book image; a recognizing unit 703 configured to recognize the individual character positions to obtain content information of individual characters, and configured to predict the text line positions to obtain a reading order of characters in the text line positions; and an arranging unit 704 configured to arrange, according to a ratio between the individual character positions and the text line positions, the content information of the individual characters following the reading order of the characters in the text line positions to obtain a recognition result of characters in the target ancient book image.

In an implementation of the example, the detecting unit 702 includes: an input sub-unit configured to input the backbone classification features into a convolution layer to obtain an individual character probability feature map and a background threshold feature map; a first determination sub-unit configured to determine, for each pixel in the target ancient book image, a probability that the pixel belongs to an individual character and a probability that the pixel belongs to a background according to the individual character probability feature map and the background threshold feature map; and a second determination sub-unit configured to determine, according to the probability that the pixel belongs to the individual character and the probability that the pixel belongs to the background, a minimum bounding rectangle of each individual character by obtaining a connected domain, as an individual character position corresponding to each individual character.

In an implementation of the example, the recognizing unit 703 includes: a cropping sub-unit configured to obtain, by image cropping, individual character image areas corresponding to the individual character positions from the target ancient book image; and a recognition sub-unit configured to recognize the individual characters in the individual character image areas through a neural network classifier to obtain the content information corresponding to the individual characters.

In an implementation of the example, the recognizing unit 703 includes: a first prediction sub-unit configured to predict the text line positions to obtain corresponding character area mask images; and a second prediction sub-unit configured to predict the reading order of the characters in text areas in the text line positions according to the character area mask images.

In an implementation of the example, the recognizing unit 703 is specifically configured to: divide the text line positions into squares having a preset size, and sequentially connecting midpoints of the squares to obtain the reading order of the characters in text areas in the text line positions.

In an implementation of the example, the arranging unit 704 includes: a calculation sub-unit configured to calculate an area of intersection of the individual character positions and the text line positions, and a ratio between the area of intersection and the individual character positions; and an arranging sub-unit configured to arrange, when the ratio satisfies a preset condition, the content information of the individual characters in the individual character positions according to the reading order of the characters in the text line positions, to obtain the recognition result of the characters in the target ancient book image.

In an implementation of the example, the apparatus further includes: a reception unit configured to receive a correction operation for the content information of the individual characters to obtain corrected content information corresponding to the individual characters.

Further, a device for recognizing an ancient book is further provided in some embodiments of the present disclosure. The device includes: a processor, a memory and a system bus, where the processor is connected to the memory via the system bus; and the memory is configured to store one or more programs including instructions, which, when executed by the processor, cause the processor to execute any implementation method of the method for recognizing an ancient book described above.

Further, a computer-readable storage medium is further provided in some embodiments of the present disclosure. The computer-readable storage medium stores instructions, which, when executed on a terminal device, causes the terminal device to execute any implementation method of the method for recognizing an ancient book described above.

From the description of the above embodiment, it can be seen that those skilled in the art can clearly understand that all or part of the steps in the method of the above example can be implemented by means of software and necessary general hardware platforms. On the basis of such understanding, the technical solution of the present disclosure can be embodied in a form of a software product in essence or a part contributing to the prior art, and the computer software product can be stored in a storage medium for example, read only memory (ROM)/random access memory (RAM), a magnetic disk and an optical disk, and includes several instructions for enabling a computer device (which can be a personal computer, a server or a network communication device such as a media gateway) to execute the method of various examples or some parts of the examples of the present disclosure.

It should be noted that each example in the description is described in a progressive manner, each example focuses on the differences from other examples, and the same and similar parts between the examples can refer to each other. Since an apparatus disclosed in the example corresponds to the method disclosed in the example, the description is relatively simple, and for relevant contents, reference can be made to partial description of the method.

It should be further noted that relational terms herein such as first and second are only used to distinguish one entity or operation from another entity or operation without necessarily requiring or implying any actual such relation or order between such entities or operations. Moreover, terms “comprise”, “include”, “contain”, or any other variations thereof are intended to cover non-exclusive inclusions, such that a process, a method, an article, or a device including a series of elements not only includes those elements, but also includes other elements that are not explicitly listed, or further includes inherent elements of the process, the method, the article, or the device. Without more restrictions, the elements defined by the sentences “comprise a . . . ” and “include a . . . ” do not exclude the existence of other identical elements in the process, method, article, or device including the elements.

The above description of the examples disclosed enables professionals skilled in the art to achieve or use the present disclosure. Various modifications to these examples are readily apparent to professionals skilled in the art, and the general principles defined herein can be implemented in other examples without departing from the spirit or scope of the present disclosure. Therefore, the present invention is not limited to the examples shown herein but falls within the widest scope consistent with the principles and novel features disclosed herein.

1. A method for recognizing an ancient book, comprising:
obtaining a target ancient book image to be recognized, and extracting classification features of the target ancient book image according to a backbone network to obtain backbone classification features;
detecting the backbone classification features and determining individual character positions and text line positions included in the target ancient book image;
recognizing the individual character positions to obtain content information of individual characters, and predicting the text line positions to obtain a reading order of characters in the text line positions; and
arranging, according to a ratio between the individual character positions and the text line positions, the content information of the individual characters following the reading order of the characters in the text line positions to obtain a recognition result of characters in the target ancient book image.

2. The method according to claim 1, wherein detecting the backbone classification features and determining individual character positions included in the target ancient book image comprises:
inputting the backbone classification features into a convolution layer to obtain an individual character probability feature map and a background threshold feature map;
determining, for each pixel in the target ancient book image, a probability that the pixel belongs to an individual character and a probability that the pixel belongs to a background according to the individual character probability feature map and the background threshold feature map; and
determining, according to the probability that the pixel belongs to the individual character and the probability that the pixel belongs to the background, a minimum bounding rectangle of each individual character by obtaining a connected domain, as an individual character position corresponding to each individual character.

3. The method according to claim 1, wherein recognizing the individual character positions to obtain content information of individual characters comprises:
obtaining, by image cropping, individual character image areas corresponding to the individual character positions from the target ancient book image; and
recognizing the individual characters in the individual character image areas through a neural network classifier to obtain the content information corresponding to the individual characters.

4. The method according to claim 1, wherein predicting the text line positions to obtain a reading order of characters in the text line positions comprises:
predicting the text line positions to obtain corresponding character area mask images; and
predicting the reading order of the characters in text areas in the text line positions according to the character area mask images.

5. The method according to claim 1, wherein predicting the text line positions to obtain a reading order of characters in the text line positions comprises:
dividing the text line positions into squares having a preset size, and sequentially connecting midpoints of the squares to obtain the reading order of the characters in text areas in the text line positions.

6. The method according to claim 1, wherein arranging, according to a ratio between the individual character positions and the text line positions, the content information of the individual characters following the reading order of the characters in the text line positions to obtain a recognition result of characters in the target ancient book image comprises:
calculating an area of intersection of the individual character positions and the text line positions, and a ratio between the area of intersection and the individual character positions; and
arranging, when the ratio satisfies a preset condition, the content information of the individual characters in the individual character positions according to the reading order of the characters in the text line positions, to obtain the recognition result of the characters in the target ancient book image.

7. The method according to claim 1, further comprising:
receiving a correction operation for the content information of the individual characters to obtain corrected content information corresponding to the individual characters.

8. (canceled)

9. A device comprising:
a processor, and a memory
wherein the memory stores one or more programs comprising instructions which, when executed by the processor, cause the device to perform a method comprising:
obtaining a target ancient book image to be recognized, and extracting classification features of the target ancient book image according to a backbone network to obtain backbone classification features;
detecting the backbone classification features and determining individual character positions and text line positions included in the target ancient book image:
recognizing the individual character positions to obtain content information of individual characters, and predicting the text line positions to obtain a reading order of characters in the text line positions; and
arranging, according to a ratio between the individual character positions and the text line positions, the content information of the individual characters following the reading order of the characters in the text line positions to obtain a recognition result of characters in the target ancient book image.

10. A non-transitory computer-readable storage medium storing instructions which, when executed by a device, cause the device to perform a method comprising:
obtaining a target ancient book image to be recognized, and extracting classification features of the target ancient book image according to a backbone network to obtain backbone classification features;
detecting the backbone classification features and determining individual character positions and text line positions included in the target ancient book image;
recognizing the individual character positions to obtain content information of individual characters, and predicting the text line positions to obtain a reading order of characters in the text line positions; and
arranging, according to a ratio between the individual character positions and the text line positions, the content information of the individual characters following the reading order of the characters in the text line positions to obtain a recognition result of characters in the target ancient book image.

11. (canceled)

12. The device according to claim 9, wherein detecting the backbone classification features and determining individual character positions included in the target ancient book image comprises:
inputting the backbone classification features into a convolution layer to obtain an individual character probability feature map and a background threshold feature map;
determining, for each pixel in the target ancient book image, a probability that the pixel belongs to an individual character and a probability that the pixel belongs to a background according to the individual character probability feature map and the background threshold feature map; and
determining, according to the probability that the pixel belongs to the individual character and the probability that the pixel belongs to the background, a minimum bounding rectangle of each individual character by obtaining a connected domain, as an individual character position corresponding to each individual character.

13. The device according to claim 9, wherein recognizing the individual character positions to obtain content information of individual characters comprises:
obtaining, by image cropping, individual character image areas corresponding to the individual character positions from the target ancient book image; and
recognizing the individual characters in the individual character image areas through a neural network classifier to obtain the content information corresponding to the individual characters.

14. The device according to claim 9, wherein predicting the text line positions to obtain a reading order of characters in the text line positions comprises:
predicting the text line positions to obtain corresponding character area mask images; and
predicting the reading order of the characters in text areas in the text line positions according to the character area mask images.

15. The device according to claim 9, wherein predicting the text line positions to obtain a reading order of characters in the text line positions comprises:
dividing the text line positions into squares having a preset size, and sequentially connecting midpoints of the squares to obtain the reading order of the characters in text areas in the text line positions.

16. The device according to claim 9, wherein arranging, according to a ratio between the individual character positions and the text line positions, the content information of the individual characters following the reading order of the characters in the text line positions to obtain a recognition result of characters in the target ancient book image comprises:
calculating an area of intersection of the individual character positions and the text line positions, and a ratio between the area of intersection and the individual character positions; and
arranging, when the ratio satisfies a preset condition, the content information of the individual characters in the individual character positions according to the reading order of the characters in the text line positions, to obtain the recognition result of the characters in the target ancient book image.

17. The device according to claim 9, wherein the method further comprises:
receiving a correction operation for the content information of the individual characters to obtain corrected content information corresponding to the individual characters.

18. The non-transitory computer-readable storage medium according to claim 10, wherein detecting the backbone classification features and determining individual character positions included in the target ancient book image comprises:
inputting the backbone classification features into a convolution layer to obtain an individual character probability feature map and a background threshold feature map;
determining, for each pixel in the target ancient book image, a probability that the pixel belongs to an individual character and a probability that the pixel belongs to a background according to the individual character probability feature map and the background threshold feature map; and
determining, according to the probability that the pixel belongs to the individual character and the probability that the pixel belongs to the background, a minimum bounding rectangle of each individual character by obtaining a connected domain, as an individual character position corresponding to each individual character.

19. The non-transitory computer-readable storage medium according to claim 10, wherein recognizing the individual character positions to obtain content information of individual characters comprises:
obtaining, by image cropping, individual character image areas corresponding to the individual character positions from the target ancient book image; and
recognizing the individual characters in the individual character image areas through a neural network classifier to obtain the content information corresponding to the individual characters.

20. The non-transitory computer-readable storage medium according to claim 10, wherein predicting the text line positions to obtain a reading order of characters in the text line positions comprises:
predicting the text line positions to obtain corresponding character area mask images; and
predicting the reading order of the characters in text areas in the text line positions according to the character area mask images.

21. The non-transitory computer-readable storage medium according to claim 10, wherein predicting the text line positions to obtain a reading order of characters in the text line positions comprises:
dividing the text line positions into squares having a preset size, and sequentially connecting midpoints of the squares to obtain the reading order of the characters in text areas in the text line positions.

22. The non-transitory computer-readable storage medium according to claim 10, wherein arranging, according to a ratio between the individual character positions and the text line positions, the content information of the individual characters following the reading order of the characters in the text line positions to obtain a recognition result of characters in the target ancient book image comprises:
calculating an area of intersection of the individual character positions and the text line positions, and a ratio between the area of intersection and the individual character positions; and
arranging, when the ratio satisfies a preset condition, the content information of the individual characters in the individual character positions according to the reading order of the characters in the text line positions, to obtain the recognition result of the characters in the target ancient book image.
